(19) United States
(12) Patent Application Publication
(10) Pub. No.: US 2006/0038094 A1
(43) Pub. Date: Feb. 23, 2006

(54) Molded bracket to join structural members

(76) Inventor: Richard A. Simmons, Atlanta, GA (US)

Correspondence Address: JENKENS & GILCHRIST, P.C., 225 WEST WASHINGTON, SUITE 2600, CHICAGO, IL, 60606, US

(21) Appl. No.: 11/118,571

(22) Filed: Apr. 29, 2005

Related U.S. Application Data
(60) Provisional application No. 60/566,285, filed on Apr. 29, 2004.

(51) Int. Cl. F16M 11/16; E04G 3/00

(52) U.S. Cl. 248/188; 248/219.1

(57) ABSTRACT

According to one embodiment of the present invention, a molded, thermoplastic bracket for joining structural elements includes a plurality of substantially identical, attachable bracket members and at least one fastener. Each of the plurality of bracket members includes an outer wall and a face. The face of each of the plurality of bracket members has a first cavity and a second cavity formed therein. The first and second cavities are adapted to receive a first and second structural member, respectively. The face of each of the plurality of bracket members also has at least one pin and at least one hole formed thereon that are adapted to align at least two of the plurality of bracket members. The at least one fastener is adapted to attach at least two of the plurality of bracket members.

### CROSS REFERENCE TO RELATED APPLICATIONS

This application claims priority to U.S. provisional application Ser. No. 60/566,285, filed on Apr. 29, 2004. The disclosure of the aforementioned provisional application is incorporated by reference in its entirety herein.

### FIELD OF THE INVENTION

The present invention relates generally to the joining of structural members and particularly to a family of support devices comprised of low-cost, molded polymer materials which perform the function of attaching structural members such as tubes, rods, pipes, and the like.

### BACKGROUND OF THE INVENTION

A myriad of methods exist for joining structural members at critical support locations along such members (most notably the ends and mid-spans of the members). Conventional methods of joining two metallic tubes, for example, often employ costly techniques such as welding. These techniques are often restrictive from the standpoint of the resources required (e.g., skilled labor and specialized equipment) and are often characterized as unforgiving relative to the alignment, adjustability, and disassembly of the permanent joint.

Other methods have been applied to the joining of structural elements that for various reasons often incorporate connective elements that can be complicated and/or costly by virtue of either the component materials or the expensive processing by which they must be manufactured.

As a result of these and other deficiencies inherent to known joints between structural elements, the present invention fills a need by providing a low-cost bracket assembly molded from inexpensive materials, aligned and assembled to structural elements with relative ease by the use of common tools and/or standard fastening methods, and easily adjusted or disassembled as necessary. The modular nature of such a design will also make feasible efficient shipment of structural assemblies which would otherwise be transported in an assembled state and would, therefore, be excessively cumbersome or voluminous.

### SUMMARY OF THE INVENTION

According to one embodiment of the present invention, a molded, thermoplastic bracket for joining structural elements is disclosed. The thermoplastic bracket comprises a plurality of substantially identical, attachable bracket members and at least one fastener. Each of the plurality of bracket members includes an outer wall and a face. The face of each of the plurality of bracket members has a first cavity and a second cavity formed therein. The first and second cavities are adapted to receive a first and second structural member, respectively. The face of each of the plurality of bracket members also has at least one pin and at least one hole formed thereon. The at least one hole partially extends into the bracket member and is adapted to receive the at least one pin formed on another of the plurality of bracket members. The at least one pin and hole are adapted to align at least two of the plurality of bracket members. The at least one fastener is adapted to attach at least two of the plurality of bracket members.

According to another embodiment of the present invention a bracket for joining structural elements is disclosed. The bracket comprises a plurality of attachable bracket members and at least one threaded fastener member. Each of the plurality of bracket members includes an outer wall, a face, and at least one aperture formed therein. The at least one aperture extends from the outer wall to the face. The face of each of the plurality of bracket members has a first cavity and a second cavity formed therein. The first and second cavities are adapted to receive a first and second structural member, respectively. The face of each of the plurality of bracket members further has at least one pin and at least one hole formed thereon. The at least one hole partially extends into the bracket member and is adapted to receive the at least one pin formed on another of the plurality of bracket members. The at least one pin and hole are adapted to align at least two of the plurality of bracket members. The at least one threaded fastener member is adapted to extend through at least one aperture and is adapted to attach at least two of the plurality of bracket members to one another. Each of the plurality of bracket members is molded from a recycled thermoplastic extrudate.

According to yet another embodiment of the present invention, a portable garment rack is disclosed. The portable garment rack comprises a base portion formed by a transverse member and a pair of substantially parallel members extending in opposite directions from the ends of the transverse member. A plurality of casters are mounted below the substantially parallel members and are adapted to movably support the garment rack. A hanging rod is horizontally secured to each of a pair of upstanding tubular stanchions opposite the base portion by a mounting element. A plurality of molded, thermoplastic bracket members are adapted to attach the pair of upstanding tubular stanchions to the base portion. Each of the plurality of bracket members includes an outer wall and a face. The face of each of the plurality of bracket members has a first cavity and a second cavity formed therein. The first cavity is adapted to receive one of the substantially parallel members and the second cavity is adapted to receive one of the upstanding tubular stanchions.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1 is a perspective view of a garment rack according to the one embodiment of the present invention.

FIG. 2 is an exploded perspective view of a bracket adapted to be used with the garment rack of FIG. 1.

FIG. 3 is a block diagram illustrating a method of manufacturing a thermoplastic composite using a plasticating extruder and chopped reinforcing fibers according to one embodiment of the present invention.

FIG. 4 is a block diagram illustrating a method of manufacturing a thermoplastic composite using a two-stage extruder and chopped reinforcing fibers according to another embodiment of the present invention.

FIG. 5a is a perspective view of a bracket member according to one embodiment of the present invention.

FIG. 5b is a perspective view of the bracket member of FIG. 5a.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

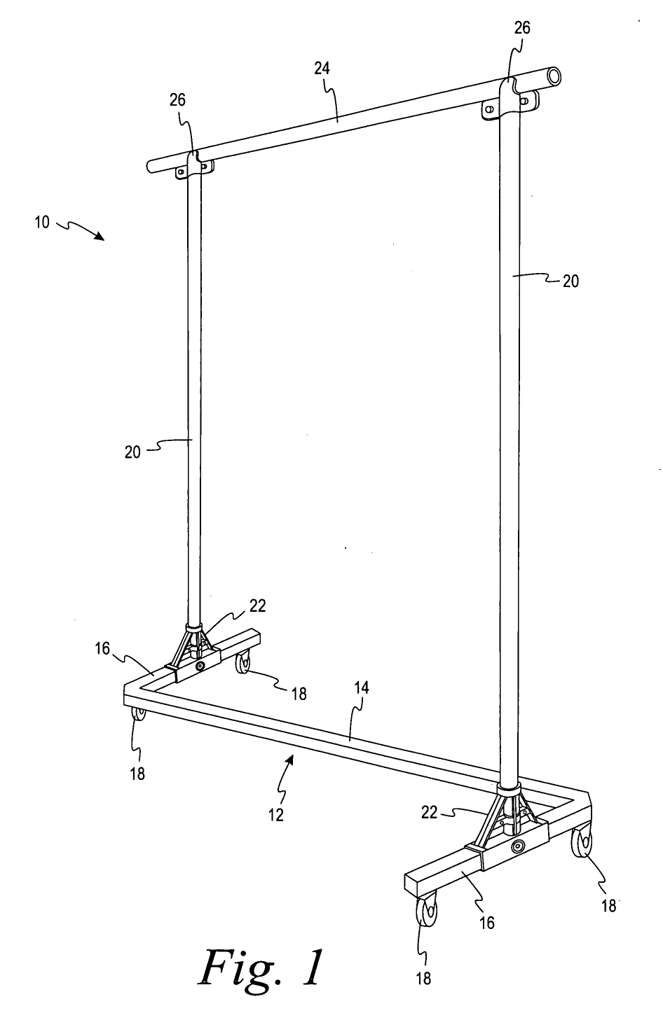

Turning now to the drawings and initially to FIG. 1, a portable garment rack 10 is illustrated, according to one embodiment of the present invention. The garment rack 10 has a generally Z-shaped base portion 12 formed by a transverse member 14 with a pair of substantially parallel members 16 extending in opposite directions from the opposite ends of the transverse member 14. It should be noted, however, that the base portion 12 can be any of a variety of shapes that are generally known in the art (e.g., rectangular, square, I-shaped, H-shaped, horseshoe shaped, etc.). A plurality of casters 18 mounted below the ends of the substantially parallel members 16 are adapted to movably support the Z-shaped base portion 12 along the ground and allow the garment rack 10 to be moved from location to location. A pair of upstanding tubular stanchions 20 are attached to the base portion 12 utilizing a plurality of brackets 22. A tubular hanging rod 24 is horizontally secured at the top of each stanchion 20 by a plurality of mounting elements 26. Additional embodiments for the above-described garment rack can be found in, for example, U.S. Pat. No. 4,054,209 entitled “Garment Rack,” which is incorporated herein by reference in its entirety.

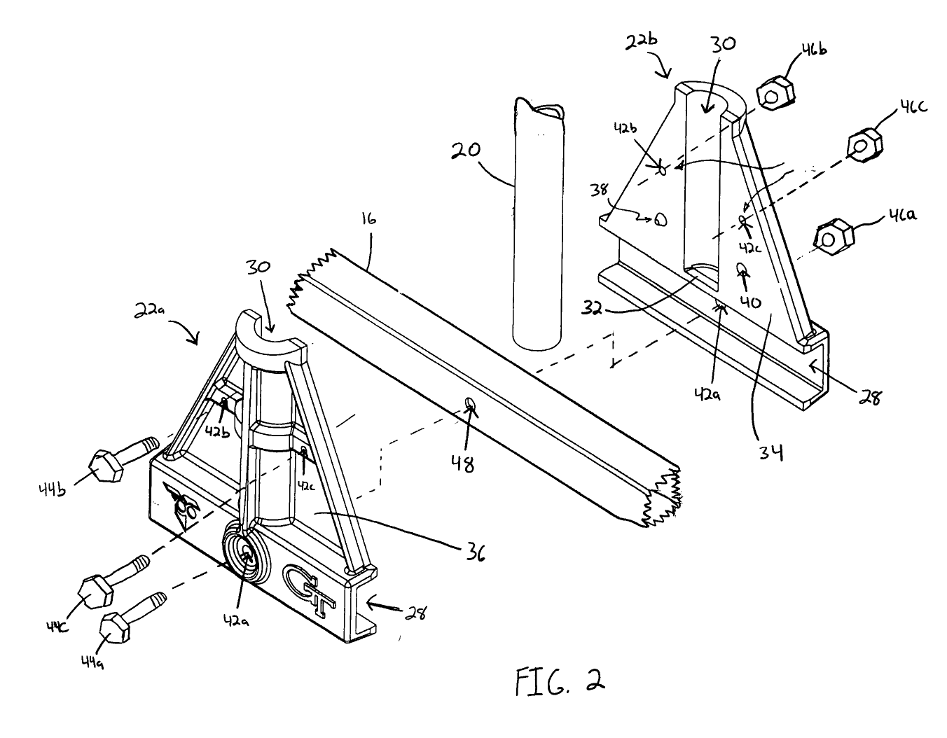

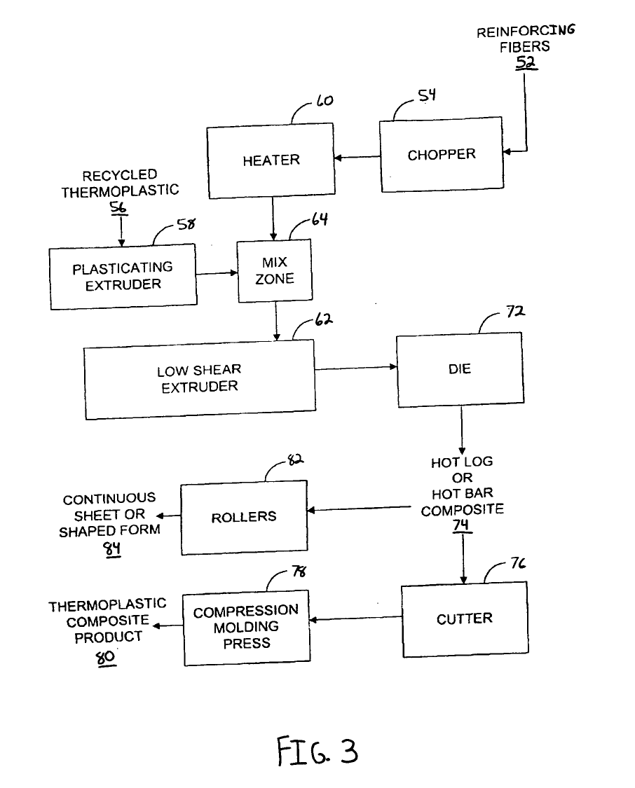

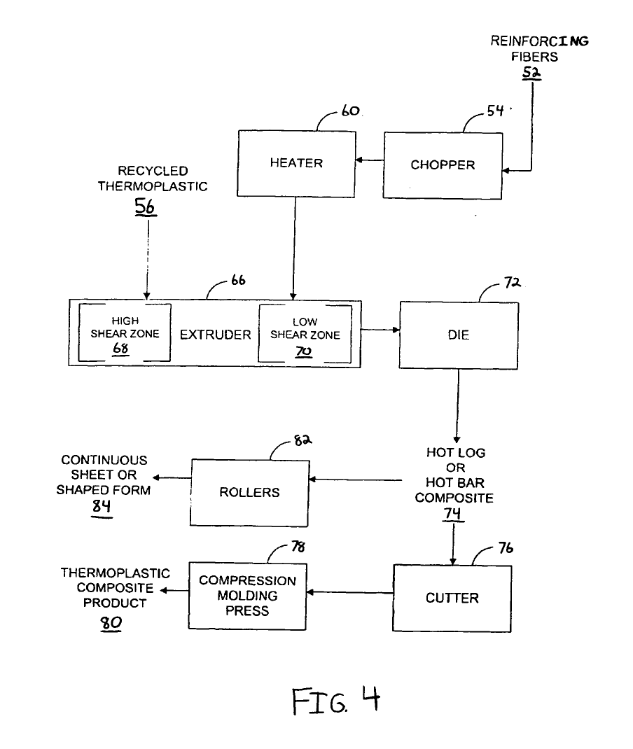

Referring now to FIG. 2, the attachment of the tubular stanchions 20 to the base portion 12 utilizing the brackets 22 is illustrated in greater detail. Each of the brackets 22 is composed of two substantially identical bracket members 22a,b that are adapted to mate with each other. The bracket members 22a,b may be formed via the compression molding of a recycled thermoplastic composite material, as will be further detailed below with respect to FIGS. 3-4. The mold used in the compression molding can be the same mold or a substantially identical mold.

The bracket members 22a,b have a plurality of cavities formed therein to engage and mount a first structural member to a second structural member. In the illustrated embodiment, a first cavity 28 is generally formed horizontally within the bracket members 22a,b while a second cavity 30 is formed generally vertically within the bracket members 22a,b. The first cavity 28 is adapted to engage a portion of the first structural member (e.g., one of the substantially parallel member 16) and the second cavity 30 is adapted to engage and attach a portion of the second structural member (e.g., stanchion 20) to the first structural member. The bracket members 22a,b can include a divide 32 that is adapted to separate the first structural member from the second structural member. The divide 32 may be used to provide a supportive ledge for a second structural member to rest upon. As illustrated, the second structural member is generally vertical. Alternatively, in embodiments where the divide 32 is absent, the second structural members engages and is supported by the first structural member.

Each of the bracket members 22a,b includes a face 34 and an outer wall 36, each having a plurality of features formed thereon. A pin 38 formed on the face 34 of the bracket member 22b is adapted to be received by a corresponding hole (not shown) formed on the face of the bracket member 22a. Similarly, the face of the bracket member 22a has a pin (not shown) formed thereon that is adapted to be received by a corresponding hole 40 formed on the face of the bracket member 22b. The holes 40 partially extend into the bracket members 22a,b, and the holes 40 and pins 38 assist in aligning the bracket members 22a,b. In the illustrated embodiment, a plurality of apertures 42a,b,c are formed through the bracket members 22a,b. The central aperture 42a extends from the respective outer wall 36 of the bracket members 22a,b to the respective first cavity 28 formed in the respective face 34 of the bracket members 22a,b, while the apertures 42b,c extend from the respective outer wall 36 to the respective face 34 on opposite sides of the respective second cavity 30. The apertures 42a,b,c are of sufficient size to allow a threaded fastener such as bolt 44a,b,c to be inserted therethrough and engage a second threaded fastener such as nut 46a,b,c on the opposite side of the bracket 22. The bolts 44a,b,c and nuts 46a,b,c attach the individual bracket members 22a,b to form the bracket 22 and, thus, secure the second structural member to the first structural member. In the embodiment illustrated in FIG. 2, an aperture 48 is formed through the parallel member 16 and is adapted to align with the respective apertures 42a formed in the respective bracket members 22a,b. The aperture 48 is adapted to allow the bolt 44a to extend therethrough to fixedly attach the parallel member 16 to the bracket 22.

In another embodiment of the present invention, yet another aperture (not shown) is formed on each of the bracket members 22a,b and extends from the respective outer wall 36 to the respective second cavity 30. This aperture is similar to the aperture 42a in that a threaded fastener such as a bolt is inserted therethrough and extends through an aperture formed in the second structural member received within the second cavity 30 so as to fixedly attach the second structural member to the bracket 22. In yet another embodiment of the present invention, the bracket members are aligned utilizing the pins 38 and holes 40 and are then sealed together via an alternative fastener, such as mechanical interlocks between the molded bracket members (e.g., snap-fit, latches, etc.). In these embodiments, the bolts 44a,b,c and nuts 44a,b,c are not required to attach the bracket members together but may still be present if desired. By utilizing a plurality of threaded hardware components or mechanically interlocking the bracket members, the bracket members can be removed from the first and second structural members and reused to attach other structural members by disengaging the fasteners.

Referring now to FIGS. 3-4, a method for manufacturing the above-described bracket members 22a,b is illustrated according to one embodiment of the present invention. A plurality of high-modulus reinforcing fibers 52 are provided to a chopper 54. The high-modulus reinforcing fibers 52 may be, for example, glass fibers, carbon fibers, natural fibers, aramid fibers, etc. A recycled thermoplastic 56 is collected and provided to a plasticating extruder 58. The reinforcing fibers 52 are chopped in the chopper 54 or provided prechopped with a length in excess of approximately ½ inch, and typically between approximately ½ inch and 2 inches in length. By minimizing the shear stresses in the mixing stage, breakage of the reinforcing fibers 52 is reduced and the length of the reinforcing fibers 52 is maintained to at least approximately ½ inch in length. Low shear mixing is facilitated by preheating the reinforcing fibers 52 such as in a heater 60 such that the fiber 52 bundles are separated, thereby reducing incidence of breakage of the fibers 52. Preheating also promotes wetting and avoids localized cooling of the recycled thermoplastic 56 as it contacts the reinforcing fibers 52.

The plasticating extruder 58 may be a relatively high-shear screw extruder. A low-shear screw extruder 62 accepts the reinforcing fibers 52 and is sized to process a recycled thermoplastic composite 68 at a low shear rate. A mixing zone 64 may be provided between the plasticating extruder 58 and the low-shear extruder 62. Alternatively, the recycled thermoplastic 56 exiting the plasticating extruder 58 may be directly mixed with the heated, chopped reinforcing fibers 52 in the low-shear extruder 62 (not shown).

Alternatively, as shown in FIG. 4, a two-stage screw extruder 66 may be used, wherein the first stage is a high-shear zone 68 and accepts the recycled thermoplastic 56 and the second stage is a low-shear zone 70 and accepts the reinforcing fibers 52. The second stage is configured with deep channels that impart a low shear rate (as compared with the shear rate of the first stage) and, therefore, reduces reinforcing fiber 52 breakage. The two-stage screw extruder 66 is used to reduce the stresses that occur when the reinforcing fibers 52 are combined with the recycled thermoplastic 56. Reducing the shear stresses in the mixing region is accomplished by lowering the shear rate of the two-stage screw extruder 66. In this regard, in one embodiment, low-shear mixing is provided by using the non-intermeshing, co-rotating twin screw extruder 55. The co-rotation of the screws creates a folding action which causes the reinforcing fibers 52 and molten recycled thermoplastic 56 to mix under low shear.

Once the reinforcing fibers 52 and the recycled thermoplastic 56 are mixed, they form a thermoplastic composite 74 that is extruded from either the low-sheer extruder 62 in FIG. 3 or the two-stage screw extruder 66 in FIG. 4 through a die 72. This extrudate composite 74 is formed by the die 72 into a large diameter rod or large cross-section bar composite, with the diameter or cross-section exceeding at least approximately ½ inch. In this manner, the extrudate composite 74 has reinforcing fibers 52 with a fiber length exceeding at least approximately ½ inch. If a larger diameter or cross-section die 72 is used, the fiber 52 orientation is randomized and fiber length is increased. If a smaller diameter or cross-section die 72 is used, fiber length can be maintained at or above approximately ½ inch by cutting the bar or rod in lengths of at least approximately 12 inch. The log or bar extrudate composite 74 may then be further shaped or flow molded while still molten. For example, as shown in FIGS. 3-4, the extrudate composite 74 may be sent directly to a cutter 76 for processing in a compression molding press 78 to yield a thermoplastic composite product 80 such as the molded, thermoplastic bracket 22 best illustrated in FIG. 2.

By quickly closing a compression mold, permitting the composite charge to flow in to fill the shape of the cavity, and setting the mold temperature below the solidification temperature of the extrudate composite 74, composite parts may be quickly made using flow molding and the thermoplastic composite 74. Additionally or alternatively, the extrudate composite 74 may be sent continuously to a series of forming and cooling rollers 82. From the rollers 82, continuous sheets or shaped forms 84 of the extrudate composite 74 are obtained. For example, if a flat shape is desired, a double-belt laminator may be used instead of forming rolls. The extrudate composite 74 or continuous sheet 84 can also be cut to form product preforms, exhibiting weights corresponding to the intended products, and formed (e.g., compression molded) into the desired products. Multiple layers of the continuous sheet 84 can also be consolidated into a thicker sheet that is then cut into blanks for compression molding.

One method of forming parts has been called “melt flow stamping” or “forming.” In general, it involves the use of pre-cut and preheated blanks placed in a matched die compression mold. Force is then applied to the blank(s) so that the composite flow forms to fill the mold cavity. In general, the blank(s) is preheated to an internal temperature of approximately 400° F. and then molded for approximately 40-60 seconds at a pressure of approximately 1500-2000 psi. In some embodiments, it is preferable that the thermoplastic composite spread to completely fill the mold and in this respect, the percentage of glass and other unmeltables (such as filler and dirt) must be controlled so that the thermoplastic composite is not too viscous to properly spread. A maximum of approximately 50%-60% unmeltables has been found to be appropriate in some embodiments.

The high-modulus reinforcing fibers 52 used in the present invention may be, for example, made from glass fibers, carbon fibers, natural fibers, aramid fibers, and combinations thereof. Care must be taken to ensure that the reinforcing fibers each have an approximate length of at least ½ inch so that an acceptable reinforcement of the extrudate composite 74 is achieved. The recycled thermoplastic 56 used in the present invention can be obtained from a variety of sources. According to one embodiment, the source of the recycled thermoplastic 56 is carpet waste due to its abundance. There are several waste streams from carpet production that result in the following forms of carpet waste: shear lint, which is typically near pure polypropylene, nylon, or polyethylene terephtalate (PET); edge trim, which is typically whole carpet scrap; separated polypropylene, which is a byproduct of a separation process developed to obtain recycled nylon; waste fiber, which is left after fiber spinning, yarn formation and tufting; and used or unsold whole carpet. The terms carpet scrap, carpet waste, or recycled carpet as used herein refer to all types of pre- and post-use carpet, waste from carpet production, post-consumer use carpet, and unused, unsold carpet, as well as material from separation processes.

Whole carpet from edge trimming, unsold carpet, and used carpet comprises nylon, polypropylene, or PET pile or tufts, at least one backing formed from one or more polyolefins such as polypropylene, and an adhesive material of styrene-butadiene rubber (SBR) applied as a latex and filled with an inorganic filler such as calcium carbonate. If the carpet is obtained post-use, it may also contain some amount of dirt. A typical carpet sample has a pile weight of approximately 40 oz. per square yard, a backing weight of approximately 8 oz. per square yard and an adhesive weight (SBR latex and filler) of approximately 24 oz. per square yard. In other words, a nylon or PET carpet sample comprises approximately 56% nylon or PET, approximately 11% polypropylene, and approximately 33% SBR plus filler. A polypropylene carpet sample comprises approximately 67% polypropylene and approximately 33% SBR plus filler. The percentages set forth herein refer to weight percentages unless otherwise noted.

While the above are generally the more prevalent forms of carpet waste and compositions of carpet, the present invention is not limited to these sources or compositions. In fact, the mechanical properties of composites formed according to the present invention are generally independent of the source or type of recycled thermoplastic used because the mechanical properties of the composites are primarily determined by high-modulus fibers such as glass fibers. For instance, the properties of glass mat reinforced recycled thermoplastic (GMRT) made with nearly pure polypropylene waste are closer to the properties of glass mat reinforced thermoplastic (GMT) made with virgin polypropylene. However, because the properties of GMT are dominated by the glass component, a GMRT made with multi-component recycled thermoplastic has comparable properties at an even lower cost. In other words, whole carpet waste does not need to be separated into its component parts in order to be used effectively in the present invention.

A benefit of the integrated manufacturing method for the extrudate composite 74 comprising thermoplastic 56 and reinforcing fibers 52 is that any scrap generated in production may be immediately recycled. Additionally, the integrated manufacturing methods shown in FIGS. 3-4 offer low-cost methods for going from starting materials (i.e., recycled thermoplastic 56 and reinforcing fibers 52) to molded and shaped extrudate composite 74 products. A more detailed description of the above-described recycled thermoplastic composite and methods is provided by U.S. Pat. No. 6,756,412 entitled “Fiber-Reinforced Recycled Thermoplastic Composite and Method,” which is incorporated herein by reference in its entirety.

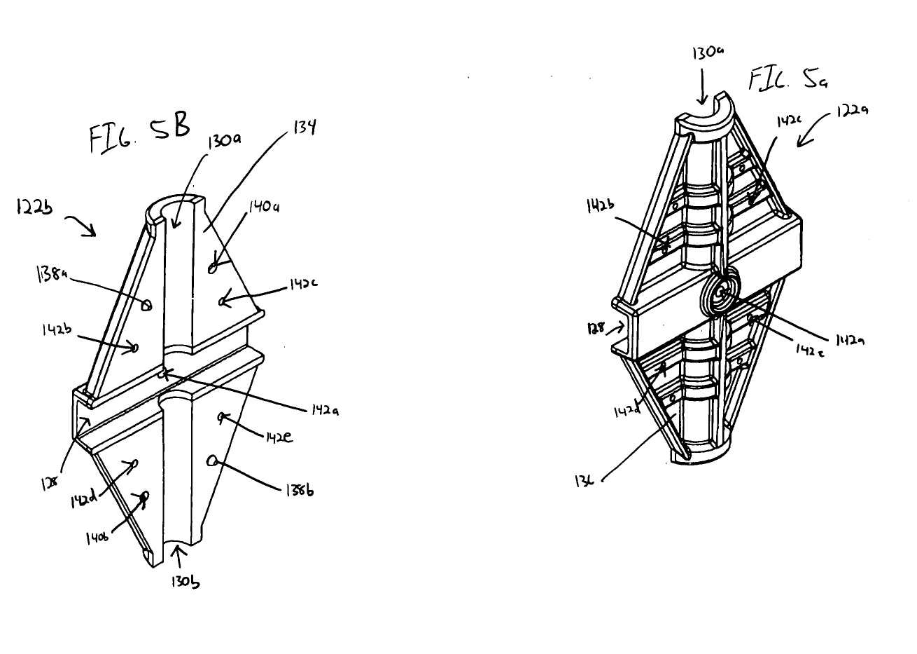

Turning now to FIGS. 5a-b, a cross-type bracket is illustrated with respect to its two identical bracket members 122a,b according to one embodiment of the present invention. The bracket members 122a,b are similar to the bracket members 22a,b (best illustrated in FIG. 2) in that each of the bracket members 122a,b includes an outer wall 136 and a face 134 having a plurality of features formed thereon. A plurality of apertures 142a,b,c,d,e extend through the respective bracket members 122a,b from the respective outer wall 136 to the respective face 134. As discussed above, each of the apertures 142a,b is adapted to allow a piece of threaded hardware to extend therethrough. The face 134 has a plurality of pins 138a,b formed thereon. Each of the plurality of pins 138a,b is adapted to be received by a hole 140a,b located on the opposite bracket member 122. A generally horizontal first cavity 128 adapted to receive a first structural member is formed in each of the bracket members 122a,b. A second cavity 130a and a third cavity 130b are formed in each of the bracket members 122a,b generally perpendicular to the first cavity 128. The second and third cavities 130a,b are adapted to receive a second structural member and a third structural member, respectively. The second and third cavities 130a,b may be identical in size and shape or may differ from each other. The bracket members 122a,b can be molded from a recycled thermoplastic composite as described above.

The above-described brackets are not limited to joining two or three members but could attach numerous additional members using straightforward designs. The brackets can be designed to attach numerous members at right angles or at oblique angles, as required. In addition, bumpers can easily be integrated into each of the bracket members to avoid marking walls, etc. The brackets could be painted or be produced in a myriad of polymer colors depending upon the source material.

It is contemplated that the structural members described herein may be made from mating components or mating members which comprise wood. For example, the mating components may be made from standard sizes of lumber such as 2′×4′, 2′×6′, or 6′×6′ lumber pieces. The mating components may include fastening hardware such as brackets or galvanized brackets which may join the pieces of wood to one another.

The primary function of the above-described molded bracket members is to provide modularity to the joining of structural members. Easy positioning of the pair of joining bracket members enables infinite adjustment of the final structural orientation and allows for field alignment. Existing methods of joining structural members often require the use of machined holes, welded elements, and/or complicated fastening systems. Some of these obstacles can be alleviated by the use of mating bracketry as described.

Additionally, products that are recycled from waste components displace steel and other virgin materials, thus, demonstrating a positive contribution to the environment. The invention disclosed herein provides cost savings, structural integrity gains, weatherability, and modularity. As a result of being composed of polymers, the linkage systems described herein would have high thermal and environmental resistance and would offer weatherability, UV stability, and durability.

Other manifestations of the inventions are conceivable and would apply to other areas of material handling. Additionally, the invention could be applied in products such as modular containers, support structures, tables, reinforcements, carports, tents, temporary structures, and docking structures.

Another potentially novel application of this invention pertains to a collapsible racking structure used on pick-up trucks or the like to carry ladders, lumber, and supplies, etc. Currently, these structures are typically constructed of welded steel or aluminum members. The invention could be applied so as to provide for an efficient means of performing the same function of the welded rack systems described above. The collapsible racking structure would offer the added flexibility of customized systems as well as the ease of disassembly and stowage. The collapsible racking structure could be assembled easily using common tools and would be expected to cost less.

While the present invention has been described with reference to one or more particular embodiments, those skilled in the art will recognize that many changes may be made thereto without departing from the spirit and scope of the present invention. Each of these embodiments and obvious variations thereof is contemplated as falling within the scope of the claimed invention, which is set forth in the following claims.

What is claimed is:

1. A molded, thermoplastic bracket for joining structural elements comprising:
a plurality of substantially identical, attachable bracket members, each of the plurality of bracket members including an outer wall and a face, the face of each of the plurality of bracket members having a first cavity and a second cavity formed therein, the first cavity being adapted to receive a first structural member and the second cavity being adapted to receive a second structural member, the face of each of the plurality of bracket members further having at least one pin and at least one hole formed thereon, the at least one hole partially extending into the respective bracket member and being adapted to receive the at least one pin formed on another of the plurality of bracket members, the at least one pin and the at least one hole being adapted to align at least two of the plurality of bracket members; and
at least one fastener adapted to attach the at least two of the plurality of bracket members.

2. The thermoplastic bracket of claim 1, wherein the fastener is a mechanical interlock adapted to attach the at least two of the plurality of bracket members.

3. The thermoplastic bracket of claim 1, wherein each of the plurality of bracket members includes at least one aperture formed therein, the at least one aperture extending from the outer wall to the face.

4. The thermoplastic bracket of claim 3, wherein the at least one fastener is threaded hardware having at least a first piece and a second piece, the first piece of threaded hardware being adapted to extend through the at least one aperture and mate with the second piece of threaded hardware to attach the at least two of the plurality of bracket members.

5. The thermoplastic bracket of claim 4, wherein the first piece of threaded hardware fixedly attaches the first structural member to the thermoplastic bracket.

6. The thermoplastic bracket of claim 1, wherein the first and second cavities are generally perpendicular to each other.

7. The thermoplastic bracket of claim 6 further comprising a third bracket formed in the face of each of the plurality of bracket members, the third cavity being adapted to receive a third structural member, the third cavity being generally perpendicular to the first cavity.

8. A bracket for joining structural elements comprising:
a plurality of attachable bracket members, each of the plurality of bracket members including an outer wall and a face, each of the plurality of bracket members including at least one aperture formed therein, the at least one aperture extending from the outer wall to the face, the face of each of the plurality of bracket members having a first cavity and a second cavity formed therein, the first cavity being adapted to receive a first structural member and the second cavity being adapted to receive a second structural member, the face of each of the plurality of bracket members further having at least one pin and at least one hole formed thereon, the at least one hole partially extending into the respective bracket member and being adapted to receive the at least one pin formed on another of the plurality of bracket members, the at least one pin and the at least one hole being adapted to align at least two of the plurality of bracket members; and
at least one threaded fastener member adapted to extend through at least one aperture formed in at least one of the plurality of bracket members and being adapted to attach at least two of the plurality of bracket members to one another,
wherein each of the plurality of bracket members is molded from a recycled thermoplastic extrudate.

9. The bracket of claim 8, wherein the recycled thermoplastic extrudate comprises a recycled thermoplastic and a plurality of high-modulus reinforcing fibers.

10. The bracket of claim 9, wherein the high-modulus reinforcing fibers are at least approximately ½ inch in length.

11. The bracket of claim 9, wherein the recycled thermoplastic is derived from recycled carpet.

12. The bracket of claim 8, wherein the plurality of bracket members are compression molded using a substantially identical mold.

13. The bracket of claim 8, wherein the bracket members are molded from blocks prefabricated from sheets of material.

14. A portable garment rack comprising:
a base portion formed by a transverse member and a pair of substantially parallel members extending in opposite directions from the ends of the transverse member;
a plurality of casters mounted below the substantially parallel members, the plurality of casters being adapted to movably support the garment rack;
a pair of upstanding tubular stanchions;
a hanging rod horizontally secured to each of the stanchions opposite the base portion by a mounting element; and
a plurality of molded, thermoplastic bracket members adapted to attach the pair of upstanding tubular stanchions to the base portion, each of the plurality of bracket members including an outer wall and a face, the face of each of the plurality of bracket members having a first cavity and a second cavity formed therein, the first cavity being adapted to receive one of the substantially parallel members and the second cavity being adapted to receive one of the upstanding tubular stanchions.

15. The portable garment rack of claim 14, wherein the plurality of thermoplastic bracket members comprise a recycled thermoplastic material and a plurality of high-modulus reinforcing fibers.

16. The portable garment rack of claim 14, wherein the plurality of thermoplastic bracket members are substantially identical.

17. The portable garment rack of claim 14, wherein the face of each of the plurality of bracket members further includes at least one pin and at least one hole formed thereon, the at least one hole partially extending into the respective bracket member and being adapted to receive the at least one pin formed on another of the plurality of bracket members, the at least one pin and hole being adapted to align at least two of the plurality of bracket members.

18. The portable garment rack of claim 14, wherein each of the plurality of bracket members includes at least one aperture formed therein, the at least one aperture extending from the outer wall to the face.

19. The portable garment rack of claim 18 further comprising at least one threaded fastener member adapted to extend through the at least one aperture formed in at least two of the plurality of bracket members, the threaded fastener member being adapted to attach the at least two of the plurality of bracket members to each other.

20. The portable garment rack of claim 14, wherein the base portion is generally Z-shaped.
